(19) United States
(12) Patent Application Publication
(10) Pub. No.: US 2012/0225150 A1
(43) Pub. Date: Sep. 6, 2012

(54) MOLDING APPARATUS FOR SEMICONDUCTOR PACKAGE

(76) Inventors: Dong-Chul HAN, Cheonan-si (KR); Sang-Geun KIM, Cheonan-si (KR); Jeong-Hoon KIM, Cheonan-si (KR); Eun-Young JUNG, Asan-si (KR); Yo-Se EUM, Cheonan-si (KR); Ho-Soo JANG, Asan-si (KR)

(21) Appl. No.: 13/411,025

(22) Filed: Mar. 2, 2012

(30) Foreign Application Priority Data
Mar. 3, 2011 (KR) 10-2011-0018733

(51) Int. Cl. B29C 45/02

(52) U.S. Cl. 425/120

(57) ABSTRACT

A molding apparatus for semiconductor package includes: a lower mold supporting a first semiconductor chip; a middle mold positioned over the lower mold and supporting a second semiconductor chip, and having a first cavity for molding the first semiconductor chip on a lower surface facing the lower mold; an upper mold positioned over the middle mold and having a second cavity for molding the second semiconductor chip on a lower surface facing the middle mold; a first supply port penetrating the lower mold and connected to the first cavity; a second supply port penetrating the lower and middle molds and connected to the second cavity; and a pressure unit positioned under the lower mold and including first and second transfer rams provided respectively in the first and second supply ports to pressure molding compound therein to supply the molding compound into the first and second cavities.

### CROSS-REFERENCE TO RELATED APPLICATION

This application claims priority under 35 U.S.C. §119 from Korean Patent Application No. 10-2011-0018733, filed on Mar. 3, 2011 in the Korean Intellectual Property Office (KIPO), the entire contents of which are herein incorporated by reference.

### BACKGROUND

1. Field

Apparatuses and methods consistent with exemplary embodiments relate to molding a semiconductor package, and more particularly, to a molding apparatus for sealing a semiconductor chip with molding compound.

2. Description of the Related Art

Generally, in order to manufacture a semiconductor package, a molding process may be performed to seal a semiconductor chip with molding resin. For example, the molding process may be performed using epoxy molding compound (EMC) to protect a semiconductor chip from outside.

A related art molding apparatus may include an upper mold and a lower mold that are clamped together to provide a cavity for molding a semiconductor chip. When a semiconductor chip is disposed in the cavity, molding compound may be injected into the cavity in a clamped state of the upper and lower molds to mold the semiconductor chip.

However, since the upper mold and the lower mold are clamped together to form the cavity, the number of semiconductor chips to be molded at one time by the molding apparatus having the upper and lower molds may be limited. Accordingly, there is a need for a molding apparatus to improve productivity of a molding process in a footprint and within a process time substantially the same as in the related art molding apparatus.

### SUMMARY

Example embodiments provide a molding apparatus for a semiconductor package capable of improving productivity of a molding process.

Example embodiments also provide methods of molding semiconductor chips using the molding apparatus.

According to an aspect of an example embodiment, there is provided a molding apparatus for a semiconductor package, the molding apparatus including: a lower mold supporting at least one first semiconductor chip; a middle mold positioned over the lower mold and supporting at least one second semiconductor chip, the middle mold having a first cavity for molding the first semiconductor chip on a lower surface facing the lower mold; an upper mold positioned over the middle mold, the upper mold having a second cavity for molding the second semiconductor chip on a lower surface facing the middle mold; a first supply port penetrating the lower mold and connected to the first cavity; a second supply port penetrating the lower mold and the middle mold and connected to the second cavity; and a pressure unit positioned under the lower mold and including first and second transfer rams, the first and second transfer rams provided respectively in the first and second supply ports to pressure molding compound in the first and second supply ports to supply the molding compound into the first and second cavities.

In example embodiments, the middle mold may include a lower middle mold and an upper middle mold, the lower middle mold may face the lower mold and have the first cavity, and the upper middle mold may face the upper mold and support the second semiconductor chip.

In example embodiments, the pressure unit may include a transfer plate that is positioned under the lower mold and the first and second transfer rams may be installed in the transfer plate to extend upwardly.

In example embodiments, the transfer plate may raise or lower the first and second transfer rams at the same time.

In example embodiments, the length of the second transfer ram may be greater than the length of the first transfer ram by the thickness of the middle mold.

In example embodiments, the second supply port may include a first port and a second port, the first port may be formed to penetrate the lower mold and the second port may be formed to penetrate the middle mold and be connected to the first port.

In example embodiments, a plurality of the first supply ports and the first ports may be formed to be arranged along the middle portion of the lower mold and a plurality of the second ports may be formed to be arranged along the middle portion of the middle mold.

In example embodiments, the first supply ports and the second supply ports may be alternately arranged.

In example embodiments, the number of the first supply ports may be identical to that of the second supply ports.

In example embodiments, the first supply ports may be arranged between at least two first semiconductor chips and the second supply ports may be arranged between at least two second semiconductor chips.

In example embodiments, the molding compound may be supplied from the first supply port into the first cavity through a first distribution block.

In example embodiments, the molding compound may be supplied from the second supply port into the second cavity through a second distribution block.

In example embodiments, the molding apparatus may further include a lower die, a middle die and an upper die that respectively hold and support the lower mold, the middle mold and the upper mold.

In example embodiments, the upper die may be fixed to the tie rod, and the middle die and the lower die may go up and down along the tie rod such that the upper mold and the middle mold are clamped together and the middle mold and the lower mold are clamped together.

In example embodiments, a stopper may be installed in the tie rod to limit a moving distance of the middle die.

In example embodiments, the middle die may further include a plurality of first middle mold ejector pins for separating the second semiconductor chip from the middle mold and a plurality of second middle mold ejector pins for supporting the first semiconductor chip.

In example embodiments, the first middle mold ejector pins may protrude from the upper surface of the middle mold by a pressure of a stopper installed in the tie rod, thereby separating the second semiconductor chip from the middle mold.

In example embodiments, the middle mold may include a lower middle mold facing the lower mold and an upper middle mold facing the upper mold, and the middle die may further include an ejector spring for lifting the upper middle mold from the middle die.

In example embodiments, a plurality of guide portions may be provided in the upper middle mold to grip the molded second semiconductor chip.

According to an aspect of another example embodiment, there is provided a molding apparatus for a semiconductor package, the molding apparatus including: a lower mold; an upper mold positioned over the lower mold; a middle mold interposed between the lower mold and the upper mold, the middle mold being clamped with the lower mold to provide at least one first molding space for molding a first semiconductor chip in the first molding space, and the middle mold being clamped with the upper mold to provide at least one second molding space for molding a second semiconductor chip in the second molding space; a first supply port penetrating the lower mold and connected to the first molding space; a second supply port penetrating the lower mold and the middle mold and connected to the second molding space; and a pressure unit positioned under the lower mold and including first and second transfer rams, the first and second transfer rams provided respectively in the first and second supply ports to pressure molding compound in the first and second supply ports to supply the molding compound into the first and second molding spaces.

According to an aspect of another example embodiment, there is provided a method of molding a plurality of semiconductor chips in a molding apparatus including a lower mold, an upper mold, and a middle mold between the lower mold and the upper mold, the method including: loading a first semiconductor chip on the lower mold and a second semiconductor chip on the middle mold; clamping the lower mold and the middle mold together to provide a first molding space above the first semiconductor chip and clamping the middle mold and the upper mold together to provide a second molding space above the second semiconductor chip; and supplying molding compound from a first supply port, which penetrates the lower mold and is connected to the first molding space, into a first molding space and from a second supply port, which penetrates the lower mold and the middle mold and is connected to the second molding space, into a second molding space, wherein the supplied molding compound solidifies to mold the first semiconductor chip and the second semiconductor chip.

According to aspects of one or more example embodiments, a molding apparatus may include a middle mold interposed between a lower mold and an upper mold. The molding apparatus may provide a first molding space between the lower mold and the middle mold and a second molding space between the middle mold and the upper mold to perform molding processes in the first and second molding spaces.

Accordingly, the molding apparatus may improve productivity of a molding process by at least two times compared with a related art molding apparatus. Additionally, identical or different semiconductor chips may be molded in the first and second molding spaces at the same time.

### BRIEF DESCRIPTION OF THE DRAWINGS

Example embodiments will be more clearly understood from the following detailed description taken in conjunction with the accompanying drawings. FIGS. 1 to 13 represent non-limiting, example embodiments as described herein, in which:

FIG. 1 is a cross-sectional view illustrating a molding apparatus for a semiconductor package in accordance with a first example embodiment;

FIG. 2 is a plan view illustrating a lower mold of the molding apparatus in FIG. 1;

FIG. 3 is a middle mold of the molding apparatus in FIG. 1;

FIG. 4 is a cross-sectional view taken along the line IV-IV′ in FIG. 2;

FIG. 5 is a cross-sectional view taken along the line V-V′ line in FIG. 3;

FIG. 6 is a cross-sectional view taken along the line VI-VI′ in FIG. 2;

FIGS. 7 to 10 are cross-sectional views illustrating a method of molding a semiconductor chip using the molding apparatus for a semiconductor package in FIG. 1;

FIG. 11 is a cross-sectional view illustrating a molding apparatus for a semiconductor package in accordance with a second example embodiment;

FIG. 12 is a plan view illustrating a middle mold in FIGS. 11; and

FIG. 13 is a cross-sectional view illustrating a method of molding a semiconductor chip using the molding apparatus in FIG. 11.

### DETAILED DESCRIPTION OF EXAMPLE EMBODIMENTS

Various example embodiments will be described more fully hereinafter with reference to the accompanying drawings, in which example embodiments are shown. Example embodiments may, however, be embodied in many different forms and should not be construed as limited to example embodiments set forth herein. Rather, these example embodiments are provided so that this disclosure will be thorough and complete, and will fully convey the scope of example embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

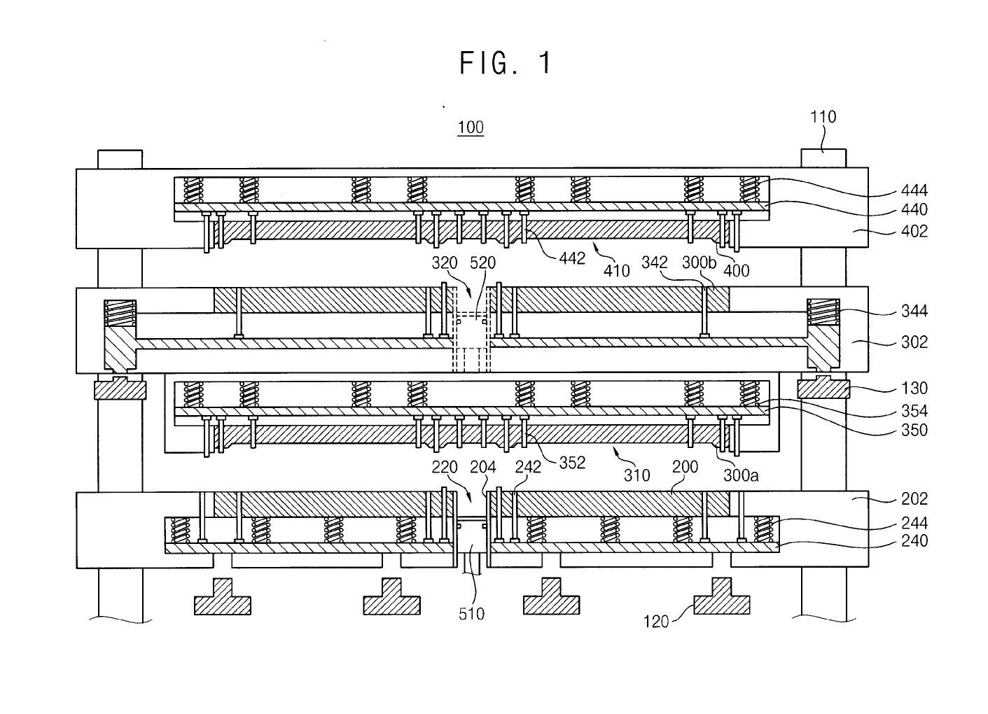

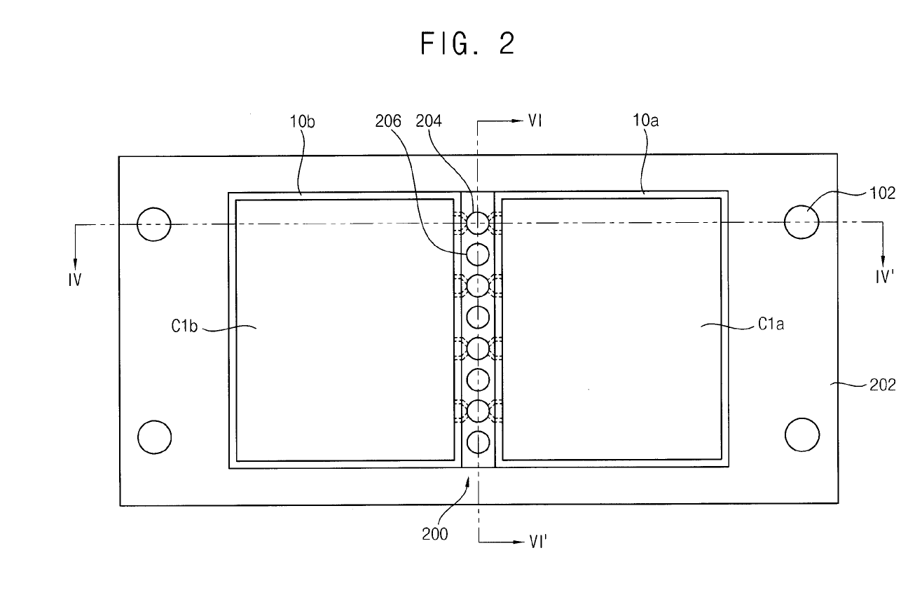

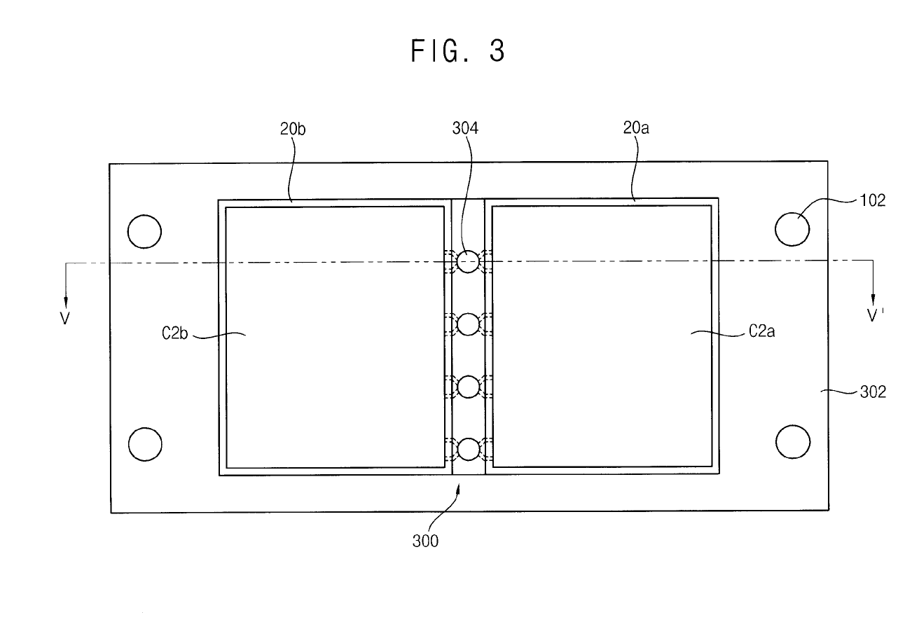

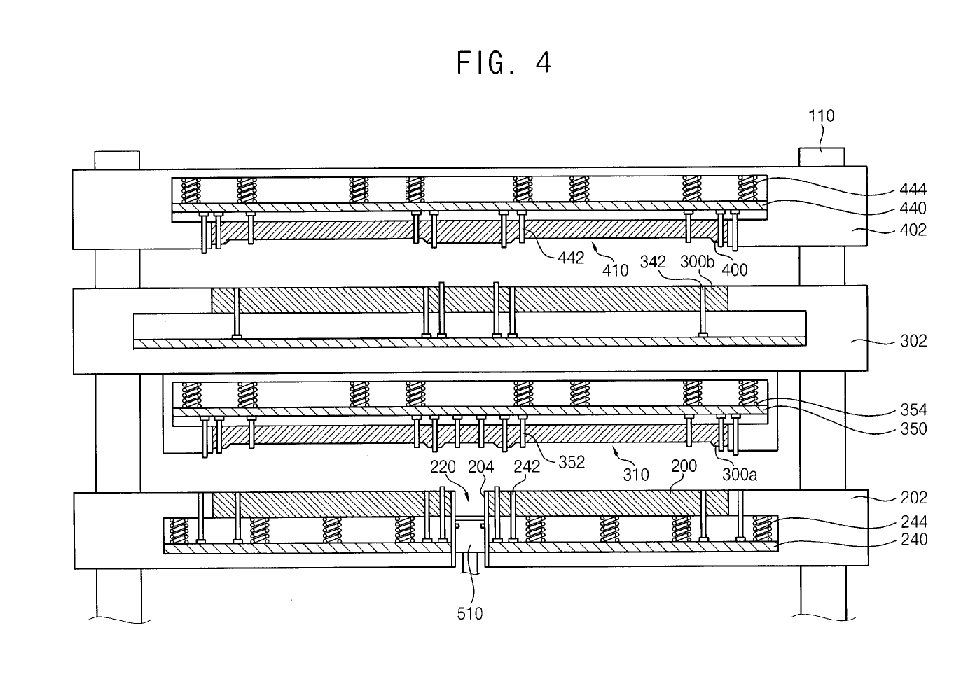

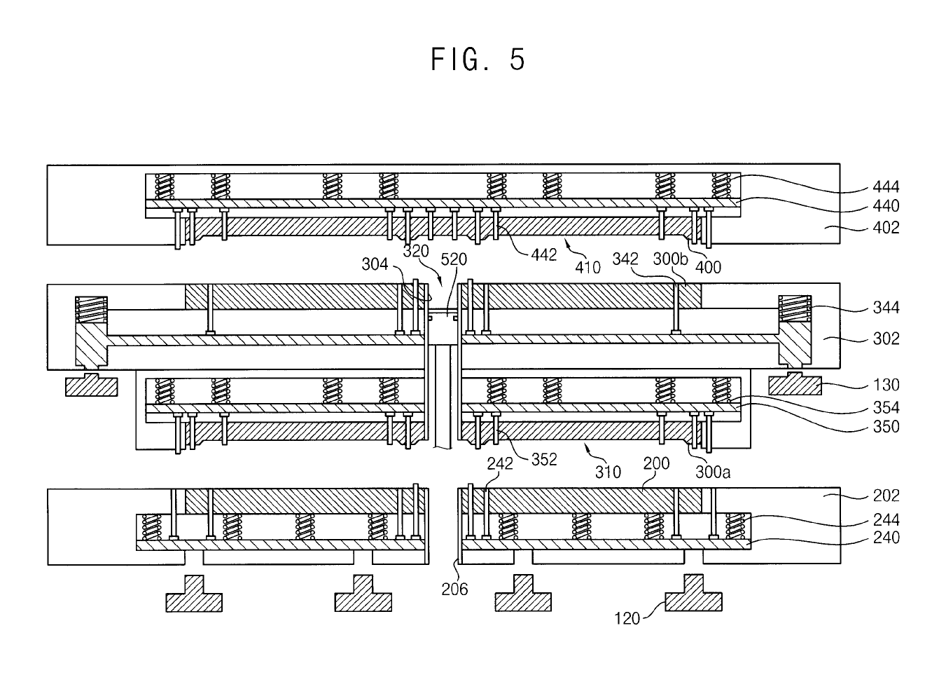

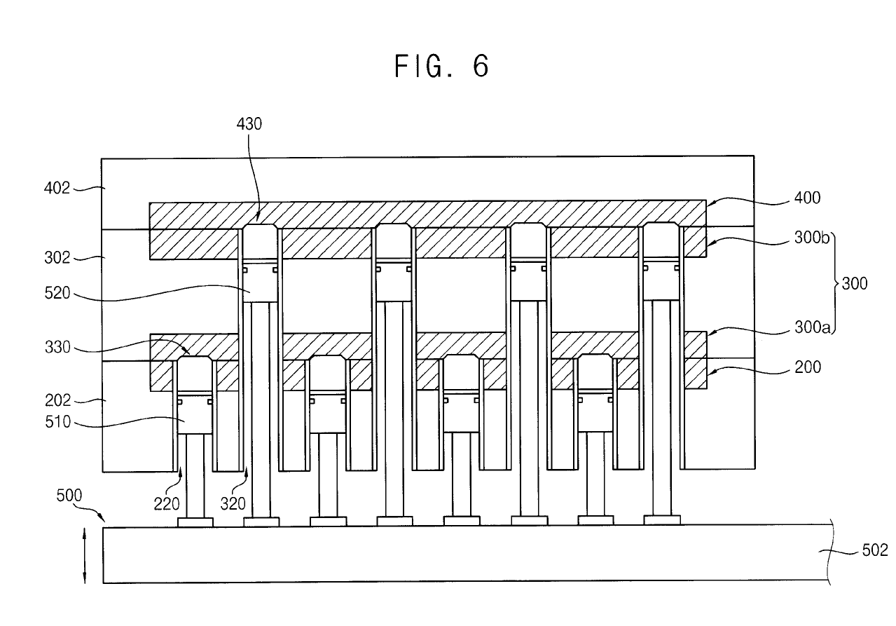

FIG. 1 is a cross-sectional view illustrating a molding apparatus 100 for a semiconductor package in accordance with a first example embodiment. FIG. 2 is a plan view illustrating a lower mold of the molding apparatus 100 in FIG. 1. FIG. 3 is a middle mold of the molding apparatus 100 in FIG. 1. FIG. 4 is a cross-sectional view taken along the line IV-IV′ in FIG. 2. FIG. 5 is a cross-sectional view taken along the line V-V′ line in FIG. 3. FIG. 6 is a cross-sectional view taken along the line VI-VI′ in FIG. 2.

Referring to FIGS. 1 to 6, a molding apparatus 100 according to a first example embodiment may include a lower mold 200, a middle mold 300, an upper mold 400, a first supply port 220 penetrating the lower mold 200, a second supply port 320 penetrating the lower mold 200 and the middle mold 300 and a pressure unit 500.

The upper mold 400 may be positioned over the lower mold 200. The middle mold 300 may be interposed between the lower mold 200 and the upper mold 400. The lower mold 200 and the middle mold 300 may be clamped together to provide a first molding space for molding at least one first semiconductor chip 10a, 10b. The middle mold 300 and the upper mold 400 may be clamped together to provide a second molding space for molding at least one second semiconductor chip 20a, 20b.

Accordingly, while the lower mold 200 and the middle mold 300 are in a clamped state, the first semiconductor chip 10a, 10b may be molded between the lower mold 200 and the middle mold 300. While the middle mold 300 and the upper mold 400 are in a clamped state, the second semiconductor chip 20a, 20b may be molded between the middle mold 300 and the upper mold 400.

In a first example embodiment, the lower mold 200 and the middle mold 300 may be clamped together to form a first cavity 310 for molding at least one first semiconductor chip 10a, 10b. The middle mold 300 and the upper mold 400 may be clamped together to form a second cavity 410 for molding at least one second semiconductor chip 20a, 20b.

The first semiconductor chip 10a, 10b may be disposed and supported on an upper surface of the lower mold 200. The first cavity 310 may be formed on a lower surface of the middle mold 300 such that the lower mold 200 and the middle mold 300 are clamped together to provide a molding space on a substrate of the first semiconductor chip 10a, 10b.

The second semiconductor chip 20a, 20b may be disposed and supported on an upper surface of the middle mold 300. The second cavity 410 may be formed on a lower surface of the upper mold 400 such that the middle mold 300 and the upper mold 400 are clamped together to provide a molding space on a substrate of the second semiconductor chip 20a, 20b.

In a first example embodiment, the middle mold 300 may include a lower middle mold 300a and an upper middle mold 300b. The lower middle mold 300a may face the lower mold 200 to provide the first cavity 310 for molding the first semiconductor chip 10a, 10b. The upper middle mold 300b may face the upper mold 400 to support the second semiconductor chip 20a, 20b.

The molding apparatus 100 for a semiconductor package may include a lower die 202, a middle die 302 and an upper die 402 that respectively hold and support the lower mold 200, the middle mold 300 and the upper mold 400.

The lower die 202 may hold and support the lower mold 200. The middle die 302 may hold and support the lower middle mold 300a and the upper middle mold 300b. The upper die 402 may hold and support the upper mold 400. The lower die 202, the middle die 302 and the upper die 402 may be connected to a tie rod 110 such that the lower die 202, the middle die 302 and the upper die 402 move relatively to one another along the tie rod 110.

In a first example embodiment, the upper die 402 may be fixed to the tie rod 110, and the middle die 302 and the lower die 202 may go up and down along the tie rod 110 such that the upper mold 400 and the middle mold 300 are clamped together and the middle mold 300 and the lower mold 200 are clamped together.

The lower die 202 may go up along the tie rod 110 to engage with the middle die 302 such that the lower mold 200 and the middle mold 300 are clamped together. The middle die 302 may go up along the tie rod 110 to engage with the upper die 302 such that the middle mold 300 and the upper mold 400 are clamped together.

As illustrated in FIGS. 1, 2, 4 and 6, the first supply port 220 may penetrate the lower mold 200 to be connected to the first cavity 310 through a first distribution block 330.

In particular, a first through hole 204 may be formed to penetrate the lower mold 200 to be used as the first supply port 220. A first port 206 may be formed adjacent to the first through hole 204 to penetrate the first lower mold 200.

In a first example embodiment, a plurality of first through holes 204 may be formed to provide a plurality of the first supply ports 220. A plurality of the first ports 206 may be formed in the lower mold 200.

The first supply ports 220 and the first ports 206 may be arranged along the middle portion of the lower mold 200. The first supply ports 220 and the first ports 206 may be arranged alternatively to each other. The number of the first supply ports 220 may be identical to that of the first ports 206.

Two first semiconductor chips 10a and 10b may be disposed on the upper surface of the lower mold 200, though it is understood that one or more other exemplary embodiments are not limited in number to two first semiconductor chips 10a and 10b. The first supply ports 220 may be provided between the two first semiconductor chips 10a and 10b. The lower mold 200 and the lower middle mold 300a may be clamped together to form the first cavities 310, that is, the molding spaces C1a and C1b for molding the first semiconductor chips 10a and 10b.

As illustrated in FIGS. 1, 3, 5 and 6, the second supply port 320 may penetrate the lower mold 200 and the middle mold 300 to be connected to the second cavity 410 through a second distribution block 430.

In a first example embodiment, the second supply port 320 may include the first port 206 and a second port 304. The second port 304 may be formed corresponding to the first port 206 to penetrate the middle mold 300. The first port 206 and the second port 304 may be connected to each other to be used as the second supply port 320.

A plurality of the second ports 304 may be formed in the middle mold 200 corresponding to the first ports 206. The second ports 304 may be arranged along the middle portion of the middle mold 300. Accordingly, the first port 206 penetrating the lower mold 200 and the second port 304 penetrating the middle mold 200 may be connected to each other to provide the second supply port 320.

Two second semiconductor chips 20a and 20b may be disposed on the upper surface of the upper middle mold 300, though it is understood that one or more other exemplary embodiments are not limited in number to two second semiconductor chips 20a and 20b. The upper middle mold 300b and the upper mold 400 may be clamped together to form the second cavities 410, that is, the molding spaces C2a and C2b for molding the second semiconductor chips 20a and 20b.

The first supply ports 220 and the second supply ports 320 may be arranged alternatively to each other. The number of the first supply ports 220 may be identical to that of the second supply ports 320. However, it is understood that in one or more other exemplary embodiments, the number and arrangement of the first and second supply ports 220 and 320 is not limited to the above-described number and arrangement.

As illustrated in FIG. 6, the pressure unit 500 may include first and second transfer rams 510 and 520 for supplying molding compound to the first and second cavities 310 and 410. The first transfer ram 510 may be provided in the first supply port 220 and the second transfer ram 520 may be provided in the second supply port 320.

The pressure unit 500 may include a transfer plate 502 that is positioned under the lower mold 200. A plurality of the first transfer rams 510 may be installed in the transfer plate 502 to extend upwardly. A plurality of the second transfer rams 520 may be installed in the transfer plate 502 to extend upwardly. Accordingly, the transfer plate 502 may raise or lower the first and second transfer rams 510 and 520 together.

The first and second transfer rams 510 and 520 may be arranged alternatively to one another, though it is understood that one or more other exemplary embodiments are not limited thereto. For example, the length of the second transfer ram 520 may be greater than that of the first transfer ram 510 by the thickness of the middle mold 300. In this embodiment, the height difference between the second transfer ram 520 and the first transfer ram 510 may be substantially identical to the distance between the upper surface of the upper middle mold 300b and the lower surface of the lower middle mold 300a.

The first transfer ram 510 may be provided within the first supply port 220 to pressure molding compound in the first supply port 220 to supply the molding compound into the first cavity 310 through the first distribution block 330.

In particular, the first distribution block 330 may connect the circular sectional shaped first supply port 220 to the first cavity 310. The molding compound may be transferred from the first supply port 220 through a cull, runner and a gate of the first distribution block 330 to the first cavity 310, and then, may be solidified to form a molding member on the substrate of the first semiconductor chip 10a, 10b.

The second transfer ram 520 may be provided within the second supply port 320 to pressure molding compound in the second supply port 320 and supply the molding compound into the second cavity 410 through the second distribution block 430.

In particular, the second distribution block 430 may connect the circular sectional shaped second supply port 320 to the second cavity 410. The molding compound may be transferred from the second supply port 320 through a cull, runner and a gate of the second distribution block 430 to the second cavity 410, and then, may be solidified to form a molding member on the substrate of the second semiconductor chip 20a, 20b.

Accordingly, the first and second transfer rams 510 and 520 may be provided in the first and second supply ports 220 and 320 respectively to pressure molding compound in the first and second supply ports 220 and 320 at the same time and supply the molding compound to the first and second cavities 310 and 410 respectively.

As illustrated in FIGS. 1, 4 and 5, in a first example embodiment, the lower die 202, the middle die 302 and the upper die 402 may include a plurality of ejector pins 242, 342, 352, 442 for supporting or removing the first and second semiconductor chips 10a, 10b, 20a, 20b.

In particular, the lower die 202 may include lower mold ejector pins 242 for separating the first semiconductor chip 10a, 10b from the lower mold 200. The lower mold ejector pins 242 may be provided to penetrate the lower mold 200 and may be connected to a lower mold ejector plate 240. The lower mold ejector plate 240 may be elastically supported in the lower die 202 by first return springs 244.

A first stopper 120 may be installed under the lower die 202 to limit a moving distance of the lower die 202. Additionally, when the lower die 202 goes down under a predetermined height, the first stopper 120 may pressure the lower mold ejector plate 240 such that the lower mold ejector pins 242 protrude from the upper surface of the lower mold 200. Accordingly, the molded first semiconductor chip 10a, 10b may be separated from the upper surface of the lower mold 200 by the lower mold ejector pins 242.

The middle die 302 may include a plurality of first middle mold ejector pins 342 for separating the second semiconductor chip 20a, 20b from the middle mold 300 and a plurality of second middle mold ejector pins 352 for supporting the first semiconductor chip 10a, 10b.

The first middle mold ejector pins 342 may be provided to penetrate the upper middle mold 300b and may be connected to a first middle mold ejector plate 340. The first middle mold ejector plate 340 may be elastically supported in the middle die 302 by second return springs 344.

A second stopper 130 may be installed in the tie rod 110 to limit a moving distance of the middle die 302. Additionally, when the middle die 302 goes down under a predetermined height, the second stopper 320 may pressure the first middle mold ejector plate 340 such that the first middle mold ejector pins 342 protrude from the upper surface of the upper middle mold 300b. Accordingly, the molded second semiconductor chip 20a, 20b may be separated from the upper surface of the upper middle mold 300b by the first middle mold ejector pins 342.

The second middle mold ejector pins 352 may be provided to penetrate the lower middle mold 300a and may connected to a second middle ejector plate 350. The second middle mold ejector plate 350 may be elastically supported in the middle die 302 by third return springs 354.

When the lower mold 200 and the lower middle mold 300a are clamped together, the lower mold 200 or the lower die 202 may contact and pressure the second middle mold ejector pins 352 protruding from the lower middle mold 300a. Accordingly, some of the second middle mold ejector pins 352 may contact and support the first semiconductor chip 10a, 10b loaded on the lower mold 200.

The upper die 402 may include a plurality of upper mold ejector pins 442 for supporting the second semiconductor chip 20a, 20b. The upper mold ejector pins 442 may be provided to penetrate the upper mold 400 and may connected to an upper ejector plate 440. The upper mold ejector plate 440 may be elastically supported in the upper die 402 by fourth return springs 444.

When the upper middle mold 300b and the upper mold 400 are clamped together, the upper middle mold 300b or the middle die 302 may contact and pressure the upper mold ejector pins 442 protruding from the upper mold 400. Accordingly, some of the upper mold ejector pins 442 may contact and support the second semiconductor chip 20a, 20b loaded on the upper middle mold 300b.

In the present example embodiment, at least two first semiconductor chips 10a, 10b may be molded between the lower mold and the middle mold and at least two second semiconductor chips 20a, 20b may be molded between the middle mold and the upper mold. However, it should be understood that the number and the shape of the semiconductor chips to be molded are not limited thereto in one or more other exemplary embodiments.

Additionally, the number of the transfer rams 510, 520 and the structures of the molds 200, 300, 400 for supporting and molding the semiconductor chips may be determined based on a type of the semiconductor chip, pressure between the molds, etc.

Further, the first semiconductor chip 10a, 10b may be substantially the same as the second semiconductor chip 20a, 20b. Alternatively, the first semiconductor chip 10a, 10b may be different from the second semiconductor chip 20a, 20b.

Hereinafter, a method of molding a semiconductor chip using the molding apparatus 100 in FIG. 1 will be explained.

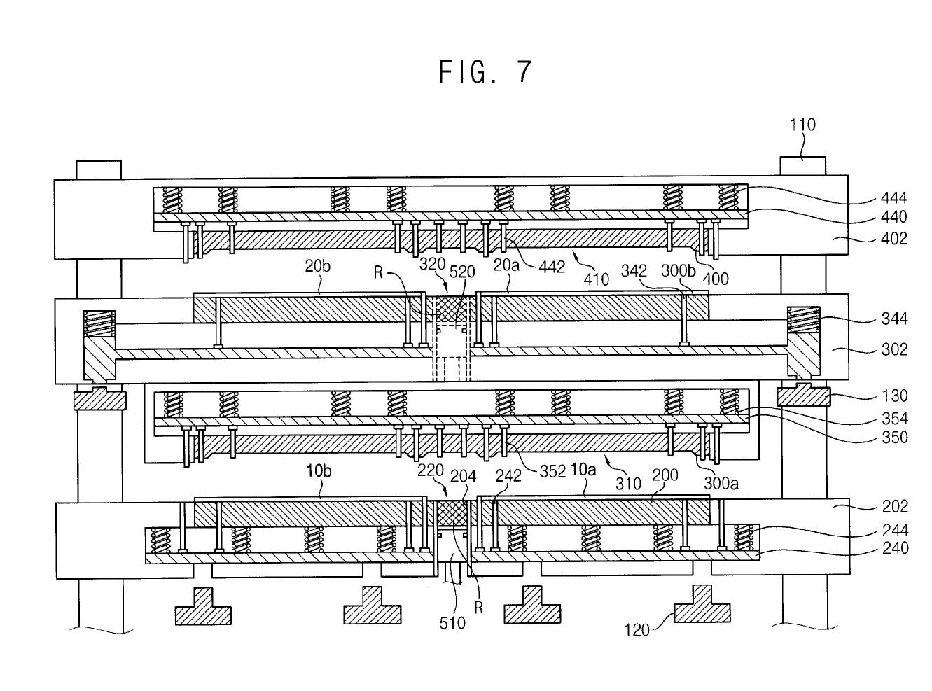

FIGS. 7 to 10 are cross-sectional views illustrating a method of molding a semiconductor chip 10a, 10b, 20a, 20b using the molding apparatus 100 for a semiconductor package in FIG. 1.

First, referring to FIG. 7, the first semiconductor chips 10a and 10b may be loaded on a lower mold 200 by a loader, and the second semiconductor chips 20a and 20b may be loaded on a middle mold 300. Molding compound (R) such as EMC may be supplied onto the first and second transfer rams 510 and 520 in the first and second supply ports 220 and 320.

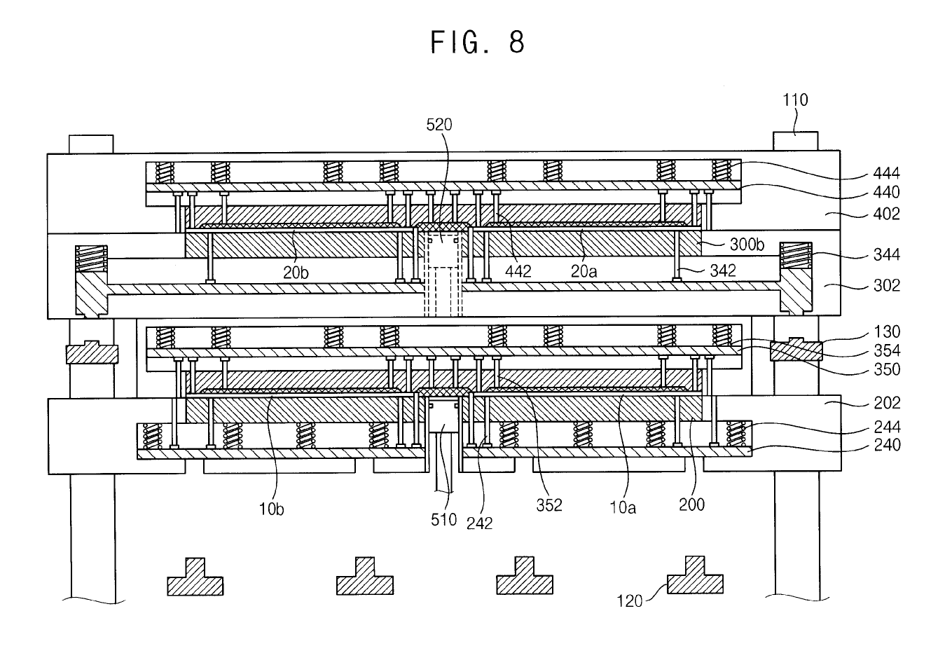

Referring to FIG. 8, the upper die 402 may be fixed to the tie rod 110, and the lower die 202 and the middle die 302 may go up along the tie rod 110 such that the lower mold 200 and the middle mold 300 are clamped together and the middle mold 300 and the upper mold 400 are clamped together.

In a first example embodiment, the lower die 202 may go up such that the lower mold 200 and the middle mold 300 are clamped together, and then, the middle die 302 may go up together with the lower die 202 along the tie rod 110. However, it is understood that one or more other exemplary embodiment are not limited thereto. For example, according to one or more other exemplary embodiments, the upper die 402 and middle die 302 may come down such that the lower mold 200 and the middle mold 300 are clamped together and the middle mold 300 and the upper mold 400 are clamped together. Moreover, according to one or more other exemplary embodiments, the middle die 302 may simply go up together with the lower die 202 along the tie rod 110.

When the lower mold 200 and the lower middle mold 300a are clamped together, some of the second middle mold ejector pins 352 protruding from the lower middle mold 300a may contact and support the first semiconductor chips 10a and 10b loaded on the lower mold 200.

When the upper middle mold 300b and the upper mold 400 are clamped together, some of the upper mold ejector pins 442 protruding from the upper mold 400 may contact and support the second semiconductor chips 20a and 20b loaded on the upper middle mold 300b.

Then, as the transfer plate 502 of the pressure unit 500 goes up, the first and the second transfer rams 510 and 520 may go up at the same time. Accordingly, the first and second transfer rams 510 and 520 may pressure the molding compound (R) in the first and second supply ports 220 and 320 at the same time and supply the molding compound to the first and second cavities 310 and 410, respectively.

In a first example embodiment, the molding compound (R) may be transferred from the first supply port 220 through the first distribution block 330 to the first cavity 310 by the pressure of the first transfer ram 510, and then, may be solidified to mold the first semiconductor chips 10a and 10b.

The molding compound (R) may be transferred from the second supply port 320 through the second distribution block 430 to the second cavity 410 by the pressure of the second transfer ram 520, and then, may be solidified to mold the second semiconductor chips 20a and 20b.

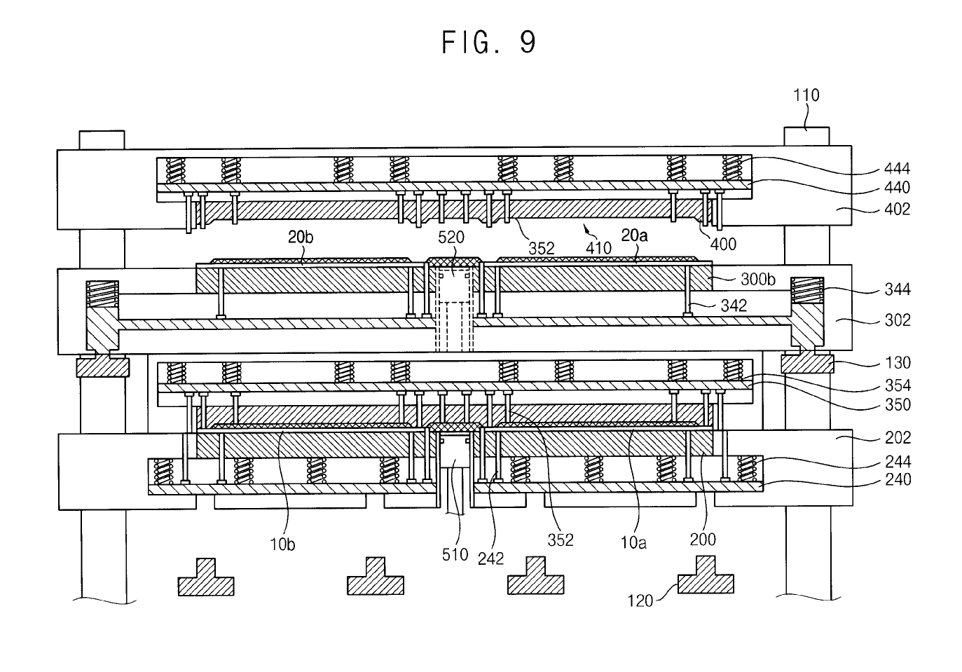

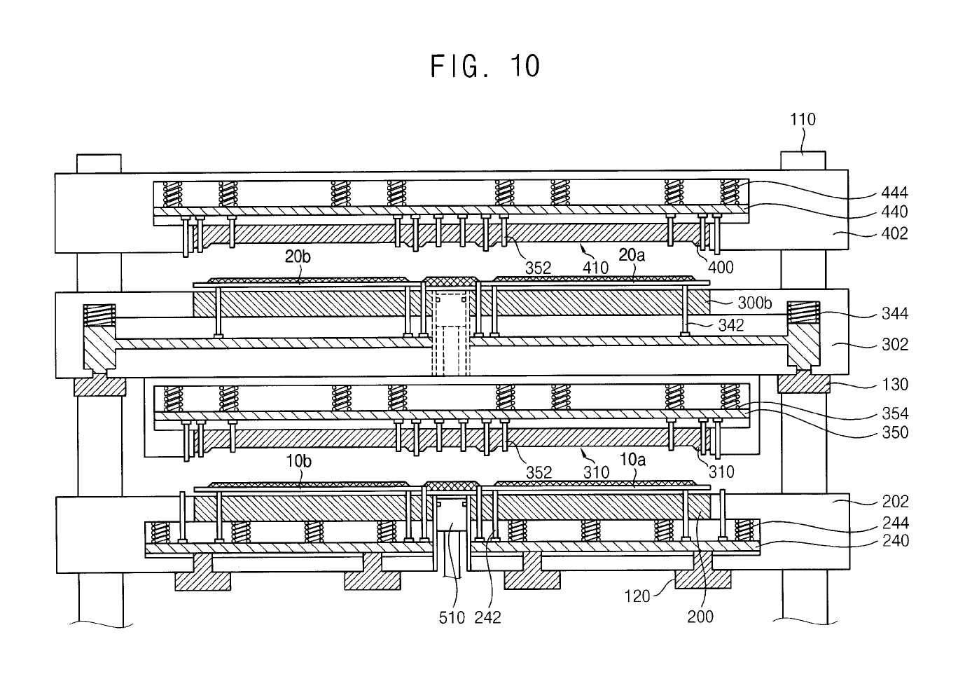

Referring to FIGS. 9 and 10, after the first and second semiconductor chips 10a, 10b, 20a, 20b are molded, the lower die 202 and the middle die 302 may go down along the tie rod 110.

In a first example embodiment, the middle die 302 may go down with the lower die 202 clamped with the middle die 302.

When the middle die 302 goes down under a predetermined height, the middle die 302 may be stopped by the second stopper 130. The first middle mold ejector pins 342 may protrude from the upper surface of the upper middle mold 300b by a pressure of the second stopper 130 to separate the molded second semiconductor chips 20a and 20b from the upper middle mold 300b.

Then, the lower die 302 may continue to go down under a predetermined height, and then, the lower die 302 may be stopped by the first stopper 120. The lower mold ejector pins 242 may protrude from the upper surface of the lower mold 200 by a pressure of the first stopper 120 to separate the molded first semiconductor chips 10a and 10b from the lower mold 200.

Next, the molded first and second semiconductor chips 10a, 10b, 20a, 20b may be unloaded by an unloader and undesired portions such as gate and cull portions of the molded semiconductor chips 10a, 10b, 20a, 20b may be removed.

As mentioned above, a molding apparatus 100 according to a first example embodiment may include the middle mold 300 interposed between the lower mold 200 and the upper mold 400. The molding apparatus 100 may provide a first molding space 310 between the lower mold 200 and the middle mold 300 and a second molding space 410 between the middle mold 300 and the upper mold 400 to perform molding processes in the first and second molding spaces 310, 410.

Accordingly, the molding apparatus 100 may improve productivity of a molding process by at least two times compared with a related art molding apparatus. Additionally, identical or different semiconductor chips may be molded in the first and second molding spaces 310, 410.

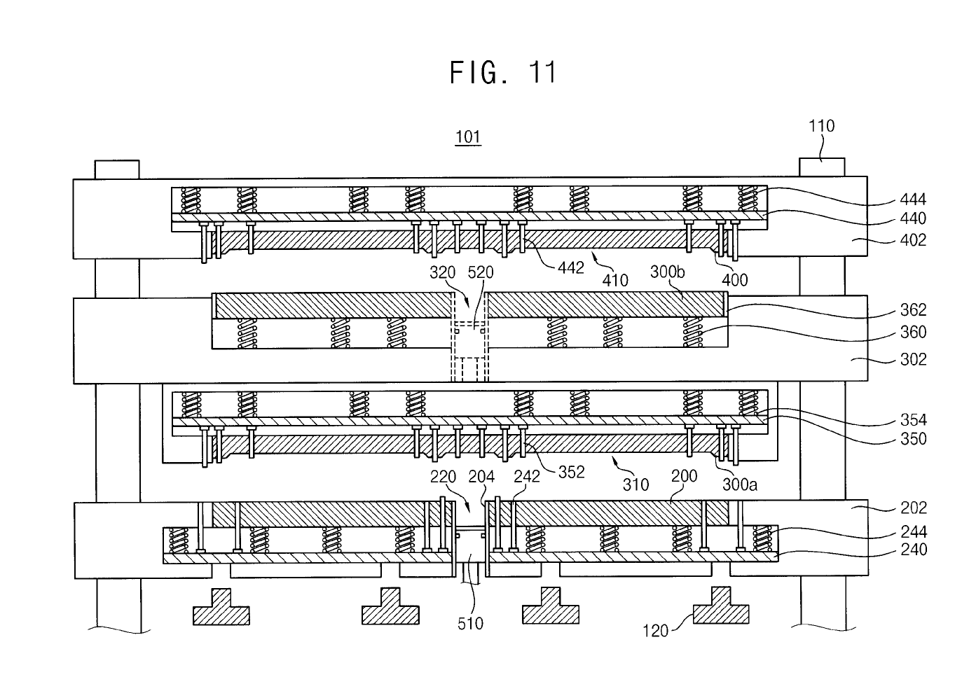

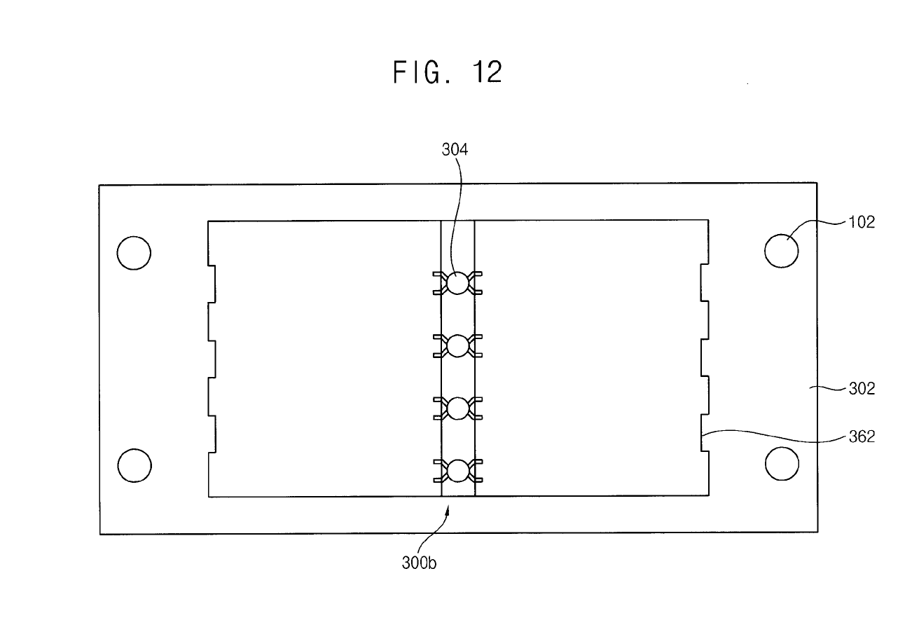

FIG. 11 is a cross-sectional view illustrating a molding apparatus 101 for a semiconductor package in accordance with a second example embodiment. FIG. 12 is a plan view illustrating a middle mold 300 in FIG. 11. The present exemplary embodiment is substantially the same as or similar to the exemplary embodiment of FIG. 1 except for an ejector unit for separating second semiconductor chips 20a, 20b therefrom. Thus, the same reference numerals will be used to refer to the same or like elements as those described in the exemplary embodiment of FIG. 1 and any further repetitive explanation concerning the above elements will be omitted.

Referring to FIGS. 11 and 12, a middle die 302 of a molding apparatus 101 according to a second example embodiment may include an ejector spring 360 for lifting an upper middle mold 300b from the middle die 302.

The ejector spring 360 may be provided under the upper middle mold 300b. When the upper middle mold 300b and the upper mold 400 are clamped together, the upper mold 400 may pressure the upper middle mold 300b. Accordingly, the upper middle mold 300b may be lowered into the middle die 302 such that the upper surface of the upper middle mold 300b is coplanar with the upper surface of the middle die 302.

When the upper middle mold 300b separates from the upper mold 400, the upper middle mold 300b may protrude from the middle die 302 by the ejector spring 360. At this time, the upper surface of the upper middle mold 300b may be higher than the upper surface of the middle die 302.

In a second example embodiment, a plurality of guide portions 362 may be provided in the upper middle mold 300b to grip the molded second semiconductor chip.

As illustrated in FIG. 12, a plurality of the guide portions 362 may be formed in an outer portion of the upper middle mold 300b to be spaced apart from one another. The guide portions 362 may be formed along the outer side portion of the upper middle mold 300b to expose a lower side portion of the second semiconductor chip 20a, 20b that is disposed on the upper middle mold 300b.

As the upper middle mold 300b is lifted by the ejector spring 360, the molded second semiconductor chip 20a, 20b may be lifted. Grippers of an unloader may be guided by the guide portions 362 to make contact with the exposed lower side portion of the second semiconductor chip 20a, 20b and grip the second semiconductor chip 20a, 20b.

It should be understood that the number, arrangement and structures of the guide portions are not limited to those of the present exemplary embodiment, but may be determined in consideration of a type of the semiconductor chip, the weight of the molding compound, etc.

Hereinafter, a method of molding a semiconductor chip 10a, 10b, 20a, 20b using the molding apparatus 101 in FIG. 11 will be explained.

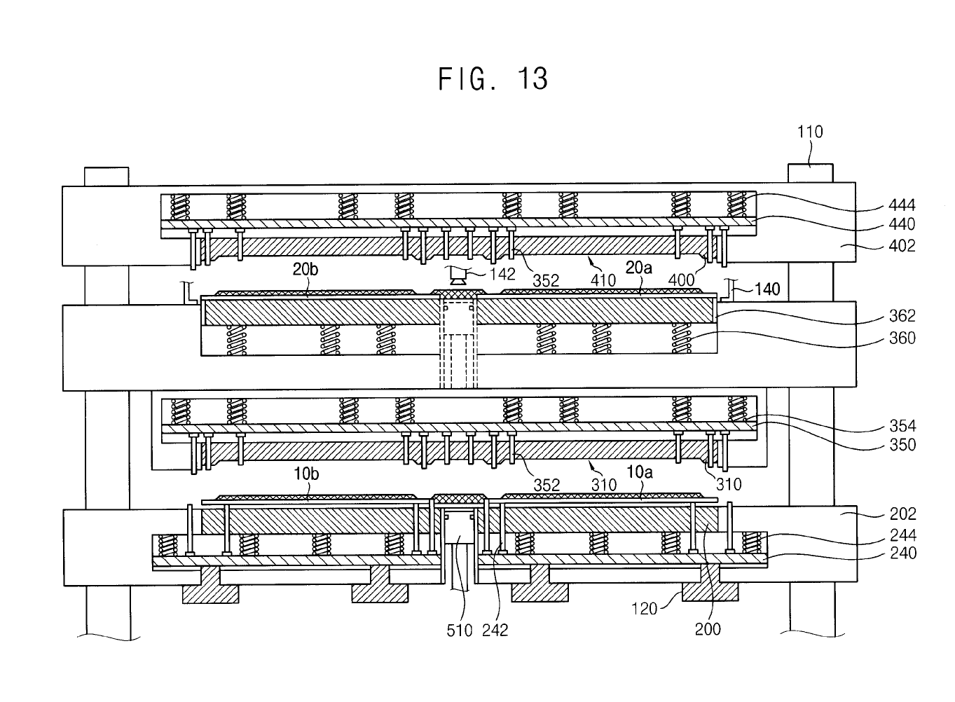

FIG. 13 is a cross-sectional view illustrating a method of molding a semiconductor chip 10a, 10b, 20a, 20b using the molding apparatus 101 in FIG. 11.

First, as illustrated in FIGS. 7 and 8, the first and second semiconductor chips 10a, 10b, 20a and 20b may be loaded on the lower mold 200 and the middle mold 300 by a loader. The molding compound (R) such as EMC may be supplied onto the first and second transfer rams 510 and 520 in the first and second supply ports 220 and 320.

The upper die 402 may be fixed to the tie rod 110, and the lower die 202 and the middle die 302 may go up along the tie rod 110 such that the lower mold 200 and the middle mold 300 are clamped together and the middle mold 300 and the upper mold 400 are clamped together.

In a second example embodiment, when the upper middle mold 300b and the upper mold 400 are clamped together, the upper mold 400 may pressure the upper middle mold 300b. Accordingly, the upper middle mold 300b may be lowered into the middle die 302 such that the upper surface of the upper middle mold 300b is coplanar with the upper surface of the middle die 302.

Then, the first and second transfer rams 510 and 520 may pressure the molding compound (R) in the first and second supply ports 220 and 320 at the same time to supply the molding compound (R) to the first and second cavities 310 and 410, respectively.

Referring to FIG. 13, when the first and second semiconductor chips 10a, 10b, 20a, 20b are molded, the lower die 202 and the middle die 302 may go down along the tie rod 110.

In a second example embodiment, when the upper middle mold 300b separates from the upper mold 400, the upper middle mold 300b may protrude from the middle die 302 by the ejector spring 360. At this time, the upper surface of the upper middle mold 300b may be higher than the upper surface of the middle die 302.

As the upper middle mold 300b is lifted by the ejector spring 360, the molded second semiconductor chip 20a, 20b may be lifted together. Grippers 140 of an unloader may move along the guide portions 362 and go up to grip the second semiconductor chip 20a, 20b. Additionally, an inhale unit 142 of the unloader may grip and transfer the molded product to a following process site.

While the above-described exemplary embodiments provide a molding apparatus with a lower mold, a middle mold, and an upper mold, it is understood that one or more other exemplary embodiments are not limited thereto. For example, according to one or more other exemplary embodiments, the molding apparatus may include a lower mold, an upper mold, and a plurality of middle molds therebetween to provide more than two layers of molding spaces. Moreover, according to one or more exemplary embodiments, each of layers of molding spaces may have a corresponding supply port through which molding compound is supplied.

As mentioned above, a molding apparatus according to example embodiments may include the middle mold interposed between the lower mold and the upper mold. The molding apparatus may provide a first molding space between the lower mold and the middle mold and a second molding space between the middle mold and the upper mold to perform molding processes in the first and second molding spaces.

Accordingly, the molding apparatus may improve productivity of a molding process by at least two times compared with a related art molding apparatus. Additionally, identical or different semiconductor chips may be molded in the first and second molding spaces at the same time.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages of the present invention. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

1. A molding apparatus for a semiconductor package, the molding apparatus comprising:
a lower mold that is configured to support a first semiconductor chip;
a middle mold that is disposed over the lower mold and which supports a second semiconductor chip, the middle mold having a first cavity for molding the first semiconductor chip on a lower surface facing the lower mold;
an upper mold positioned over the middle mold, the upper mold having a second cavity configured to mold the second semiconductor chip on a lower surface facing the middle mold;
a first supply port that penetrates the lower mold and is connected to the first cavity;
a second supply port that penetrates the lower mold and the middle mold and is connected to the second cavity; and
a pressure unit that is disposed under the lower mold and comprises a first transfer ram provided in the first supply port to pressure molding compound into the first supply port to supply the molding compound into the first cavity, and a second transfer ram provided in the second supply port to pressure molding compound into the second supply port to supply the molding compound into the second cavity.

2. The molding apparatus of claim 1, wherein the middle mold comprises a lower middle mold that faces the lower mold and has the first cavity, and an upper middle mold that faces the upper mold and supports the second semiconductor chip.

3. The molding apparatus of claim 1, wherein the pressure unit further comprises a transfer plate that is disposed under the lower mold, and the first and second transfer rams extend upwardly from the transfer plate.

4. The molding apparatus of claim 3, wherein the transfer plate simultaneously raises the first and second transfer rams and simultaneously lowers the first and second transfer rams.

5. The molding apparatus of claim 3, wherein a length of the second transfer ram is greater than a length of the first transfer ram by a thickness of the middle mold.

6. The molding apparatus of claim 1, wherein the second supply port comprises a first port that penetrates the lower mold, and a second port that penetrates the middle mold and is connected to the first port.

7. The molding apparatus of claim 6, wherein a plurality of first supply ports and first ports are arranged along a middle portion of the lower mold and a plurality of second ports is arranged along a middle portion of the middle mold.

8. The molding apparatus of claim 7, wherein the plurality of first supply ports and the plurality of second supply ports are alternately arranged.

9. The molding apparatus of claim 7, wherein the number of the plurality of first supply ports is identical to the number of the plurality of second supply ports.

10. The molding apparatus of claim 1, wherein the first supply port is arranged between at least two first semiconductor chips supported by the lower mold and the second supply ports is arranged between at least two second semiconductor chips supported by the middle mold.

11. The molding apparatus of claim 1, wherein the molding compound is supplied from the first supply port into the first cavity through a first distribution block.

12. The molding apparatus of claim 1, wherein the molding compound is supplied from the second supply port into the second cavity through a second distribution block.

13. The molding apparatus of claim 1, further comprising:
a lower die that holds and supports the lower mold;
a middle die that holds and supports the middle mold; and
an upper die that holds and supports the upper mold.

14. The molding apparatus of claim 13, wherein the upper die is fixed to a tie rod, and the middle die and the lower die move up along the tie rod to clamp the upper mold and the middle mold together and to clamp the middle mold and the lower mold together.

15. The molding apparatus of claim 14, further comprising a stopper disposed in the tie rod to limit a moving distance of the middle die.

16. The molding apparatus of claim 13, wherein the middle die comprises a plurality of first middle mold ejector pins that separates the second semiconductor chip from the middle mold, and a plurality of second middle mold ejector pins that supports the first semiconductor chip.

17. The molding apparatus of claim 16, wherein the first middle mold ejector pins protrude from the upper surface of the middle mold by a pressure of a stopper located in the tie rod, thereby separating the second semiconductor chip from the middle mold.

18. The molding apparatus of claim 13, wherein the middle mold comprises a lower middle mold facing the lower mold and an upper middle mold facing the upper mold, and the middle die comprises an ejector spring that lifts the upper middle mold from the middle die.

19. The molding apparatus of claim 18, further comprising a plurality of guide portions in the upper middle mold to grip the molded second semiconductor chip.

20. The molding apparatus of claim 18, wherein when the upper middle mold and the upper mold are clamped together, the upper middle mold compresses the ejector spring and lowers into the middle die such that the upper surface of the upper middle mold is coplanar with an upper surface of the middle die, and when the upper middle mold separates from the upper mold, the ejector spring lifts the upper middle mold such that the upper surface of the upper middle mold is higher than the upper surface of the middle die.

21. The molding apparatus of claim 1, wherein at lease one of a size and a shape of the molded first semiconductor chip, molded by the first cavity, is different from a size and a shape of the molded second semiconductor chip, molded by the second cavity.

22. A molding apparatus for a semiconductor package, the molding apparatus comprising:
a lower mold;
an upper mold that is disposed over the lower mold;
a middle mold that is interposed between the lower mold and the upper mold, to provide a first molding space in which a first semiconductor chip is molded when clamped with the lower mode, and to provide a second molding space in which a second semiconductor chip is molded when clamped with the upper mold;
a first supply port that penetrates the lower mold and is connected to the first molding space;
a second supply port that penetrates the lower mold and the middle mold and is connected to the second molding space; and
a pressure unit that is disposed under the lower mold, and is configured to supply molding compound from the first supply port into the first molding space and to supply molding compound from the second supply port into the second molding space.

23. The molding apparatus of claim 22, wherein the pressure unit comprises:
a first transfer ram provided in the first supply port to pressure the molding compound in the first supply port to supply the molding compound into the first molding space; and
a second transfer ram provided in the second supply port to pressure the molding compound in the second supply port to supply the molding compound into the second molding space.

24. (canceled)

25. (canceled)

26. (canceled)
